(19) United States
(12) Patent Application Publication
(10) Pub. No.: US 2017/0115405 A1
(43) Pub. Date: Apr. 27, 2017

(54) X-RAY DETECTOR AND/OR GAMMA DETECTOR WITH LIGHT BIAS

(71) Applicant: Siemens Healthcare GmbH, Erlangen (DE)

(72) Inventors: Markus BIELE, Erlangen (DE); Patric BUECHELE, Langenau (DE); Rene FISCHER, Erlangen (DE); Oliver SCHMIDT, Erlangen (DE); Sandro Francesco TEDDE, Weisendorf (DE)

(21) Appl. No.: 15/286,805

(22) Filed: Oct. 6, 2016

(30) Foreign Application Priority Data
Oct. 23, 2015 (DE) 102015220793.5

(51) Int. Cl. G01T 1/24

(52) U.S. Cl. CPC G01T 1/24

(57) ABSTRACT

A detector for X-ray and/or gamma radiation, including at least one radiation source and at least one interlayer in the case of an electrode, wherein a neutralization of trap states at the electrode and rise times and decay times in the millisecond range, as are required for the application, can be achieved by the corresponding arrangement. A method for producing the detector is also disclosed.

### PRIORITY STATEMENT

The present application hereby claims priority under 35 U.S.C. §119 to German patent application number DE 102015220793.5 filed Oct. 23, 2015, the entire contents of which are hereby incorporated herein by reference.

### FIELD

At least one embodiment of the present invention generally relates to a detector for X-ray and/or gamma radiation, comprising at least one radiation source and at least one interlayer in the case of an electrode, wherein a neutralization of trap states at the electrode and rise times and decay times in the millisecond range, as is required for the application, can be achieved by the corresponding arrangement, and to a method for producing the detector.

### BACKGROUND

Detectors based on amorphous silicon (indirect conversion) and amorphous selenium (direct conversion) constitute the current prior art. FIG. 1 shows the principles for direct conversion and FIG. 2 those for indirect conversion. With direct conversion an X-ray quantum 1 is absorbed in the semiconductor 2, wherein electron/hole pairs 2a, 2b are generated which then migrate to the electrodes (anode or cathode, for example pixel electrodes) and are detected there. With indirect conversion the X-ray quantum 1 is absorbed in the scintillator 2 which in turn emits radiation 2′ with low energy (e.g. visible light, UV or IR radiation) which is then detected by way of a photodetector 3 (e.g. photodiode).

Indirect X-ray conversion therefore includes, for example, the combination of a scintillator layer (e.g. Gd2O2S or CsI with different doping agents such as terbium, thallium, europium, etc.; layer thicknesses typically 0.1 mm to 1 mm) and a photodetector (preferably photodiode). The emission wavelength of the scintillator light due to X-ray conversion overlaps with the spectral sensitivity of the photodetector.

In the case of direct X-ray conversion, for example, the X-ray radiation is in turn directly converted into electron/hole pairs and these are electronically read out (e.g. amorphous Se). Direct X-ray conversion into selenium is conventionally performed with up to 1 mm thick layers which are preloaded in the kV range. While indirect conversion detectors, in particular, have prevailed due to the fact that they are easy and inexpensive to produce, direct converters generally have a much better resolution.

Hybrid-organic X-ray detectors have the potential to replace existing X-ray detector concepts (e.g. indirect conversion concepts—CsI to a:Si or direct converter made of a:Se).

Scintillators are embedded in an organic semiconductor matrix, X-ray radiation is absorbed in the scintillator, and the re-emitted visible light is absorbed by the organic semiconductor matrix and converted into electron-hole pairs. Driven by an externally applied electrical field, the charges are transported to the contacts and are detected there.

To achieve sufficiently high X-ray detection, the detection layers should be very thick, typically 100-500 μm.

DE 10 2010 043 749 A1, for example, therefore discloses X-ray detectors based on the above-described concept of the hybrid-organic detectors, wherein scintillators are either dispersed directly into the organic semiconductor solution or sprayed on in a “co-spray process” at the same time as the organic semiconductor material.

DE 10 2013 226 365 A1 describes the optimum mixing ratio of scintillator to organic content. DE 10 2013 226 339 A1 also discloses a production method for producing thick layers. DE 10 2014 203 685 A1 furthermore describes a photoelectric intensifying screen.

It is known from DE 10 2011 077 961 A1 that trap states can form, in particular at the interfaces or boundaries between the X-ray detector layer and the electrodes. These impede the charge carrier extraction, in particular in the case of low current densities. As a result, components with interfaces of this kind are very slow and have rise and decay times in the region of seconds. For this purpose DE 10 2011 077 961 A1 describes the introduction of interlayers, whereby the number of trap states can be reduced.

In a:Si X-ray detectors what is known as “flashing” (a type of illumination) with light reduces what is known as “ghosting”. The background to this is that the a-Si detectors, which can be made, for example, of a stacked CsI scintillator with a layer thickness of about 450 μm, are externally preloaded in the blocking direction before the X-ray pulse. X-ray light is converted by way of the scintillator into visible light and is absorbed by an a-Si detector according to the dose. The photocurrent produced thereby results in a voltage drop within the diode. A higher voltage than before is then applied and a count is then made as to which current is necessary to achieve the new voltage. This current then corresponds to the X-ray intensity. The diode is then exposed to a light pulse (flash). This light pulse discharges all diodes and fills all deep trap states. Identical conditions are therefore established for each X-ray pulse. The intensity of the “flash” light has to be optimized very carefully in order to be able to completely fill the traps. Trap filling allows the “ghosting”/memory effect, which can persist for several minute, to be reduced, in particular with intensive X-ray irradiation and high-contrast structures. Modern photodetectors with “flashing” achieve a retention of 0.3% at 1 s after X-ray irradiation, and this can be found, for example, in HOHEISEL M. ET AL.: “Amorphous Silicon X-Ray Detectors”, in: Ninth ISCMP, pages 1-9, (http://www.mhoheisel.de/docs/ISCMP91996112.pdf).

U.S. Pat. No. 6,723,995 B2 describes the introduction of a luminescent layer onto a direct conversion X-ray detector, which removes charge carriers at the interface from the trap states with X-ray radiation. One drawback of the proposed solution is that the light intensity depends on the incident X-ray power and is inhomogeneous in the presence of an object.

Furthermore, in CdZnTe detectors the polarization in the material can be reduced with the aid of light. CdZnTe is a direct semiconductor for ionizing rays, specifically X-ray and gamma radiation. The inclusion of Te in the crystal leads to trap states which bind a considerable proportion of the charge carriers generated by radiation. The trapping of charge carriers builds up a polarization in the detection layer which reduces the electrical field and thereby prevents the effective extraction of the charge carriers. It is known that this effect can be reduced by the irradiation of light (COLA, ADRIANO ET AL.: “Electric Field and Current Transport Mechanisms in Schottky CdTe X-ray Detectors under Perturbing Optical Radiation”, in: sensors 2013, Vol. 13, pp. 9414-9434).

However, an effective method for reducing trapping is still required in order to thereby achieve improved, sensitive and fast detection of X-ray and/or gamma radiation.

### SUMMARY

The inventors have discovered that the trap states at the interface or the boundary can be effectively suppressed by the irradiation of light, and the rise/decay behavior of the detector, e.g. X-ray detector lies in the region of milliseconds. Charge carriers, which have been generated in bulk due to the irradiation of ionizing radiation, e.g. X-ray quanta, migrate to the contacts and are captured there in trap states. These trap states are filled by the irradiation of the additional light, and the charge carriers generated by the radiation, for example X-ray radiation, can be dissipated unhindered via the contacts.

The introduction of an interlayer, which conducts charge carriers, absorbs the irradiated light but does not generate a photocurrent, can improve the result still further. The interlayer ensures that no, or only a slight, signal is measured which would reduce the sensitivity to radiation, e.g. X-ray radiation, due to the irradiated light.

The inventors have discovered that in particular in hybrid organic radiation detectors such as X-ray detectors, low-energy defects form at the boundaries/interfaces between the absorber layer and the electrodes. These hinder charge carrier extraction from the cell and therefore the dynamic behavior of the detector, e.g. X-ray detector, as a whole. With simultaneous visible (e.g. visible light) excitation of the interlayer, the use of additional interlayers leads to improved dynamic behavior. Due to the absorption of photons in the interlayer, excitons are generated therein which result in filling of the density of states of the low-energy defects. Filled defects can no longer adversely affect charge carrier extraction, so the dynamic behavior of the detector is improved.

The interlayer can be chosen such that the radiation (in particular X-ray quanta) to be detected is not attenuated and the electrical properties of the detector, e.g. an X-ray diode, are not hindered.

According to a first embodiment, the present invention relates to a detector for X-ray and/or gamma radiation, comprising:

(a) a first radiation source which irradiates a first electrical contact with a first radiation which lies outside of the wavelength range to be detected;

(b) a first electrical contact, optionally on a substrate;

(c) a first interlayer;

(d) a first layer which absorbs the radiation to be detected;

(e) optionally a second interlayer;

(f) a second electrical contact; and

(g) optionally a second radiation source which irradiates the second electrical contact with a second radiation which lies outside of the wavelength range to be detected;

wherein the first electrical contact, optionally the substrate and the first interlayer and/or the second electrical contact and the second interlayer are essentially transmissible for the radiation to be detected, and the first interlayer essentially absorbs the first radiation of the first radiation source.

In a further embodiment of the present invention relates to a method for producing a detector for X-ray and/or gamma radiation, comprising:

(i) providing a first electrical contact, optionally on a substrate;
(ii) coating the first electrical contact with a first interlayer;
(iii) coating the first interlayer with a first layer which absorbs the X-ray and/or gamma radiation;
(iv) optionally coating with a second interlayer;
(v) coating with a second electrical contact;
(vi) providing a first radiation source which irradiates the first electrical contact with a first radiation which lies outside of the wavelength range to be detected, on the side of the first electrical contact opposite the second electrical contact; and
(vii) optionally providing a second radiation source which irradiates the second electrical contact with a second radiation which lies outside of the wavelength range to be detected, on the side of the second electrical contact opposite the first electrical contact;
wherein the first electrical contact, optionally the substrate and the first interlayer and/or the second electrical contact and the second interlayer are essentially transmissible for the radiation to be detected, and the first interlayer essentially absorbs the first radiation of the first radiation source.

Further embodiments of the present invention can be found in the dependent claims and the detailed description.

### BRIEF DESCRIPTION OF THE DRAWINGS

The accompanying drawings are intended to illustrate embodiments of the present invention and to impart a further understanding thereof. In conjunction with the description they serve to explain concepts and principles of the invention. Other embodiments and many of the advantages mentioned result with regard to the drawings. The elements of the drawings are not necessarily shown true to scale in relation to each other. Unless stated otherwise, identical elements, features and components, those with the same function and those which act in the same way are each provided with the same reference numerals in the Figures of the drawings.

FIGS. 1 and 2 schematically contrast the concepts of direct X-ray conversion (FIG. 1) and indirect X-ray conversion (FIG. 2).

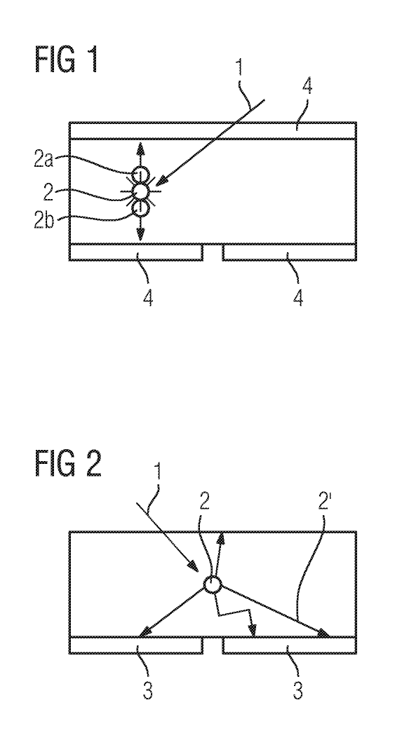

FIG. 3 schematically shows an embodiment of a conventionally used detector which can be fitted with a transparent lower electrode or bottom electrode.

FIG. 4 schematically shows an example embodiment of an inventive detector, with an interlayer and light source being provided herein the lower region, moreover, in addition to a transparent bottom electrode.

In addition, FIG. 5 schematically illustrates a further example embodiment of an inventive detector, wherein, compared to FIG. 4, an interlayer, a transparent upper electrode or top electrode and a light source are also provided in the upper region.

FIG. 6 shows experimental results for the external quantum efficiency for an example inventive detector.

Further experimental results for an example inventive detector, namely the dark current with and without light, can be seen in FIG. 7.

FIGS. 8 and 9 show example experimental results for the X-ray pulse response with (FIG. 8) and without light (FIG. 9) for an inventive detector.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Within the scope of the embodiments of the invention, gamma and X-ray radiation comprises radiation in an energy range of 1 keV to 5 MeV (1.24 nm to 0.25 pm). Both types of radiation are ionizing radiation, with X-ray radiation having its origin in electron shells, for example by way of transitions and deceleration, whereas gamma radiation is produced by nuclear processes, for example by decay/fusion. The energy ranges of the two types of radiation can overlap. According to specific embodiments X-ray radiation comprises the range from 1 keV to 250 keV (1.24 nm to 5 pm). According to specific embodiments X-ray radiation is detected, i.e. a detector for X-ray radiation, or a method for producing the same, is disclosed.

The term “essentially” in respect of transmissibility for radiation and/or radiation absorption expresses that 100% transmissibility for radiation and/or radiation absorption does not conventionally exist, and this can depend on the radiation sources used and the materials of the corresponding components, for example layers and/or electrical contacts. According to specific embodiments the term “essentially” in respect of the transmissibility for radiation and/or radiation absorption means that at least 50%, more preferably at least 80%, even more preferably at least 95%, of the radiation is let through and/or absorbed, based on the respective radiation. In this connection the transmissibility between the transmissibility with respect to ionizing radiation, X-ray and/or gamma radiation to be detected, and the radiation from the first and/or second radiation source can be different, so, for example, semi-transparent electrodes let through only 50% of the first and/or second radiation, e.g. the light, to fill the traps, whereas more than 99% of the X-ray radiation can pass through.

According to a first embodiment, the present invention relates to a detector for X-ray and/or gamma radiation, for example X-ray radiation, comprising:

(a) a first radiation source which irradiates a first electrical contact with a first radiation which lies outside of the wavelength range to be detected;

(b) a first electrical contact, optionally on a substrate;

(c) a first interlayer;

(d) a first layer which absorbs the radiation to be detected;

(e) optionally a second interlayer;

(f) a second electrical contact; and

(g) optionally a second radiation source which irradiates the second electrical contact with a second radiation which lies outside of the wavelength range to be detected;

wherein the first electrical contact, optionally the substrate and the first interlayer and/or the second electrical contact and the second interlayer are essentially transmissible for the radiation to be detected, and the first interlayer essentially absorbs the first radiation of the first radiation source.

According to specific embodiments the first layer is a layer which converts incident radiation, for example X-ray radiation, directly or quasi-directly into charge carriers, with the layer being connected to the two electrical contacts—each with or without interlayer—via which the generated charge carriers can be diverted from the absorbing first layer.

The type of first and second radiation source is not particularly limited and can be appropriately provided insofar as the radiation sources irradiate radiation at a wavelength or a wavelength range which lies outside of the wavelength range to be detected, i.e. not in the X-ray or gamma range, and comprises, for example, LEDs, OLEDs, etc. According to specific embodiments the first and optionally second radiation source can irradiate light in the UV (ultraviolet; 10 nm to 380 nm), vis (visible; 380 nm to 780 nm) and/or IR (infrared; 780 nm to 1 mm) range.

Trap states at the boundary (interface) of electrical contact/interlayer can be filled in respect of detection by the irradiated radiation of the first and optionally second radiation source(s). Compared to related concepts such as in the case of a:Si detectors, the light can be sent through the existing interlayer during ionizing radiation, e.g. X-ray radiation. These methods would not be possible in the case of detectors such as a:Si detectors without interlayer since a larger photocurrent is generated there by the irradiation of light, and this overlays the signal to be detected, e.g. X-ray signal.

An embodiment of the present invention first of all results in the advantage of faster response/decay behavior. The introduction of an interlayer, which essentially absorbs the irradiated radiation of the first and optionally second radiation source, but preferably essentially does not generate any photocurrent, means that the sensitivity of the detector, e.g. X-ray detector, is not adversely affected by the irradiated radiation. The advantage also results that there is no increase in the “dark current” due to the irradiation of radiation of the first and optionally second radiation source(s), and uniform sensitivity to the radiation to be detected, for example X-ray radiation, is thereby ensured.

According to specific embodiments the first and/or second radiation is capable of illuminating the respective contact over a large area—in particular during irradiation with the radiation to be detected—in particular in a region in which the electrical contacts are attached to the respective interlayer. Irradiation with the respective light source is preferably essentially homogeneous, i.e. to more than 70%, 90% or 99%, and in particular is homogeneous.

According to specific embodiments the first and/or second radiation source is an essentially monochrome, preferably monochrome radiation source (i.e. no black radiators), e.g. a monochrome light source, an LED and/or a laser, in particular which the interlayers conventionally have a band absorption and transmit wavelengths outside of the band.

The type of irradiation is not particularly limited and can occur in a directed or undirected manner insofar as it is ensured that at least some of the radiation of the first and optionally second radiation source is irradiated into the corresponding interlayer. Directed irradiation into the interlayer can also be ensured, for example, by the provision of appropriate mirrors, etc. The radiation sources can be provided in various forms, for example as light points, elongate radiation sources, as planar radiation sources, etc. According to specific embodiments the first and/or second radiation source(s) is/are OLED films which are applied in a planar manner to the first and/or second electrical contact(s). Alternatively, a planar light-emitting electrochemical cell, etc. can also be used. These are preferably essentially transparent, in particular completely transparent, for the radiation to be detected, so they are provided on a side on which the radiation to be detected is irradiated, for example by a third radiation source. An appropriate film can be glued, for example, to the corresponding electrode or substrate.

According to specific embodiments the first and optionally second radiation source(s) are essentially transparent or completely transparent or at least uniformly partially transparent for the radiation to be detected. This is advantageous in particular on the side at which the radiation to be detected occurs, for example on the side of the second electrical contact if a third radiation source for the radiation to be detected is provided on this side. Of course a planar first radiation source such as an OLED can also be used on the first side in such a case, although conventional light sources can also be used there, in particular line sources such as LEDs and/or lasers.

The first and second radiation sources can, where both are provided, be the same of different—e.g. in respect of their form and/or emitted radiation, wherein, in respect of their radiation, they should accordingly also be geared to the interlayer used in each case, so they are different according to specific embodiments.

According to specific embodiments it is ensured in the inventive detector that the first and optionally second radiation source(s) irradiate(s) the respective interlayer if radiation to be detected is irradiated into the detector. This can occur, for example, using an appropriate controller that ensures this. According to specific embodiments the inventive detector can therefore comprise a control unit which ensures that the first and optionally second radiation source(s) irradiate(s) the respective interlayer if radiation to be detected is irradiated into the detector. Particularly advantageous is a controller which switches on the first and optionally second radiation source(s) before the radiation to be detected is irradiated, e.g. 10 seconds before. The first and optionally second radiation source(s) can be switched off, for example, after 10 seconds, once reading of the detector is complete. Alternatively, the controller can also ensure that the first and optionally second radiation source(s) is/are permanently switched on.

The first and optionally second interlayer(s) is/are introduced between the first, the X-ray and/or gamma radiation absorbing layer, and the respective contact illuminated with radiation, which in each case essentially absorbs or completely absorbs the radiation irradiated by the first and optionally second radiation source(s), but preferably does not generate a photocurrent, or generates only a slight photocurrent.

The material of the first and second interlayers is not particularly limited insofar as it essentially absorbs and preferably completely absorbs the radiation of the first or second radiation source respectively. According to specific embodiments the absorption spectrum of the first or second interlayer respectively at least essentially matches the radiation of the first or second radiation source respectively or comprises at least the wavelengths of the irradiated radiation. Furthermore, on the side at which the radiation to be detected penetrates, the material for the radiation to be detected is essentially transmissible and preferably completely transmissible. For example, this material can be matched to the matrix of the first layer, which absorbs the radiation to be detected, in order to avoid trapping and to ensure simple production of the layers, for example by joint sintering, in order to achieve good transitions. The material can also be matched to the respective electrical contact, for example in respect of a charge transfer.

Therefore, for example the first layer can comprise an organic donor-acceptor mixture comprising two organic compounds, wherein, according to specific embodiments, the material of the first interlayer then comprises only one of the two organic compounds. Example donor-acceptor mixtures are disclosed below in conjunction with the first layer. These then produce the corresponding materials of the interlayers, of which some are mentioned Table 1 below in connection with the respective electrical contact and an irradiated wavelength of the respective first and/or second radiation source(s) (light bias).

TABLE 1
Example materials for the interlayer

| material | HOMO (−eV) | LUMO (−eV) | wavelength/light-bias | | electrode |
|---|---|---|---|---|---|
| P3HT | 4.9 | 2.7 | green | (~550 nm) | anode |
| TFB | 5.16 | 2 | UV | (~390 nm) | anode |
| MEH-PPV | 5.3 | 3.0 | green | (~550 nm) | anode |
| MDMO-PPV | 5 | 2.8 | green | (~550 nm) | anode |
| PCDTBT | 5.5 | 3.6 | green | (~550 nm) | anode |
| PCBM | 6.1 | 3.7 | blue | (~450 nm) | cathode |
| PC70BM | 6 | 3.9 | blue-green | (~450 nm) | cathode |
| Poly(benzimidazobenzo- | 5.9 | 4 | green | (~550 nm) | cathode |
| phenanthroline) (BBL) | | | | | |
| Boramer ™-T03 | 6.2 | 3 | UV | (~390 nm) | cathode |

In addition many other hole transport materials from OLED development can be considered for the anode-side interlayer, and many electron transport materials from OLED development can be considered for the cathode-side interlayer.

The first and second interlayers, where both are provided, can also be the same or different and can in turn depend, for example, on the radiation to be detected or the material of the first layer which detects the radiation since the interlayers are preferably matched to this layer in order to minimize trapping. The first and second layers can also differ in some other way, for example in their thickness.

According to specific embodiments essentially no photocurrent is generated in the first layer and, where present, second interlayer by absorption of the X-ray and/or gamma radiation to be detected, and more preferably no photocurrent is generated otherwise in the interlayers either, for example by externally incident radiation such as, for example, UV-radiation. This can be ensured by an appropriate choice of material, for example by providing an organic donor-acceptor mixture comprising two organic compounds in the first layer, and the material of the first and optionally second interlayer(s) only comprising one of the two organic compounds, it being possible to match the choice to the respective electrical contact, in particular with direct or quasi-direct converters in the detection layer, i.e. the first layer, which result in electron and hole transport.

According to an embodiment of the invention, the first and/or second interlayer(s) should have strong absorption for the first or second radiation respectively. This can ensure that there is a minimization of the absorption or the irradiated first and optionally second radiation, also called bias light, in the first layer, the detection layer, for example comprising a bulk heterojunction (BHJ), and a generation, associated therewith, of charge carriers. A corresponding strong absorption in the interlayer, for example by a correspondingly thick interlayer, is therefore advantageous in particular if the detection layer for X-ray and/or gamma radiation contains materials, such as, e.g. a bulk heterojunction (BHJ), which would be excited by the first and optionally second radiation. The materials and radiation sources can again be suitably adjusted here, although varying the thickness of the interlayer can give a greater variation in respect of the further components of the detector such as the radiation sources and the first layer.

According to specific embodiments there are no further interlayers present aside from the first interlayer and optionally second interlayer.

If the first layer for the detection of X-ray and/or gamma radiation comprises a BHJ—according to specific embodiments—the HOMO level of the respective interlayer ideally corresponds on the anode side to the HOMO level of the BHJ. According to specific embodiments the energy level of the interlayer on the anode side is at least less than or equal to the energy level of the hole conductor of the BHJ, however. The material of the interlayer on the anode side can match the hole conducting material of the BHJ. Furthermore, the material of the interlayer on the cathode side can match the electron conducting material of the BHJ. According to specific embodiments the LUMO level of the interlayer on the cathode side corresponds to the LUMO level of the BHJ if the first layer for the detection of the X-ray and/or gamma radiation comprises a BHJ.

According to specific embodiments the energy level of the interlayer on the cathode side is at least greater than or equal to the energy level of the electron conductor of the BHJ, however. The energy barrier between the respective interlayer and the BHJ can be minimized by appropriate design of the interlayer(s) in order not to impede charge transport. In particular, effects at the boundary between the respective interlayer and the BHJ can be reduced or even ruled out by the use of the hole conductor or electron conductor used in the BHJ. According to specific embodiments, due to the high layer thickness the first layer or the detecting part can also be formed as a photoconductor in which the first contact and the second contact are made of the same material.

According to specific embodiments the first interlayer has a thickness which matches at least the penetration depth of the first radiation of the first radiation source, preferably at least three times the penetration depth of the radiation of the first radiation source, more preferably at least five times the penetration depth of the radiation of the first radiation source, even more preferably at least ten times the penetration depth of the radiation of the first radiation source. According to specific embodiments the second interlayer has a thickness which matches at least the penetration depth of the second radiation of the second radiation source, preferably at least three times the penetration depth of the radiation of the second radiation source, more preferably at least five times the penetration depth of the radiation of the second radiation source, even more preferably at least ten times the penetration depth of the radiation of the second radiation source. A signal generated by the radiation of the respective radiation source can be reduced or prevented in the first layer hereby.

The penetration depth may be derived from the Lambert-Beer law: I=I_0*exp(−alpha*d)

I=transmitted intensity
I_0=initiated intensity
alpha=absorption coefficient
d=layer thickness/penetrated depth of the medium

The penetration depth delta is defined as the layer thickness at which the intensity of the electromagnetic radiation has fallen to 1/e^{th} part of the initial value, and therefore the reciprocal value of the wavelength-dependent absorption coefficient.

delta=1/alpha

For example, with a P3HT:PCBM donor-acceptor mixture/bulk heterojunction the absorption coefficient in the case of green light (wavelength 550 nm) is about 7.7e+04 cm-1, and this corresponds to a penetration depth of delta=130 nm.

According to specific embodiments, the irradiated first and optionally second radiation is/are almost completely or completely absorbed, i.e. to more than 90%, 95%, 99% or even to 100%, in the corresponding interlayer. This can be achieved by an appropriately thick interlayer preferably having a layer thickness d of at least d=5δ. In this case only 0.67% of the original intensity then reaches the first layer. The thickness of the interlayer(s) is particularly preferably d=10δ or more, so only 0.0045% or less of the original intensity of the respective first and/or second radiation source(s) reaches the first layer. A thick interlayer has the advantage, moreover, that the undesirable injection of electrons and the increase in the dark current associated therewith can be suppressed by the large spatial separation between the electrical contact and the first layer for detection with the presence of a BHJ therein, in particular the electron conductor of the BHJ (e.g. PCBM).

The first layer is not particularly limited insofar as it can detect the radiation to be detected.

As described above, the first and/or second interlayer(s) in the material can be matched to the first layer, although this possibility also exists in another way. For example, the respective interlayer can therefore also be matched to the respective electrical contact.

According to specific embodiments, the first layer is made of a material which converts the absorbed X-ray and/or gamma radiation directly or quasi-directly into charge carriers. In particular, the reduction in defects at the boundaries to the electrical contacts is advantageous for these charge carriers.

For example, the first layer can comprise scintillator particles which are embedded in an organic matrix.

The organic matrix is not particularly limited and can comprise, for example, at least one photoactive material and/or the detector can comprise more than one type of scintillator particle.

According to specific embodiments, the photoactive material is in the form of a donor/acceptor mixture. The donor/acceptor mixture is also called a bulk heterojunction here.

A typical representative of a strong electron-donator (low electron affinity) is e.g. the conjugated polymer poly-(3-hexylthiophene) (P3HT). Typical materials for electron acceptors (high electron affinity) are fullerenes and their derivatives, such as e.g. [6,6]-phenyl-C61 butyric acid methylester (PCBM). In addition, however, materials such as polyphenylenevinylene and its derivatives such as the cyano derivative CN-PPV, MEH-PPV (poly(2-(2-ethylhexyloxy)-5-methoxy-p-phenylenvinylene)), CN-MEH-PPV, or phthalocyanine, etc., can also be used. Further example compounds are mentioned below in combination with suitable scintillator particles.

According to specific embodiments, the material of the organic matrix absorbs radiation in a wavelength range in which the scintillator particles emit radiation. According to specific embodiments the photoactive material of the organic matrix has, moreover, at least one absorption maximum at a wavelength which corresponds to an emission wavelength of the scintillator particle, preferably the emission wavelength of a maximum of the emission of the scintillator particle.

Example material combinations for a combination of scintillator particles with photoactive organic materials for various wavelengths are as follows:

Suitable green scintillators are, for example, Gd₂O₂S:Pr,Ce (gadolinium oxysulfide, doped with praseodymium and cerium with an emission maximum at approximately 515 nm), Gd₂O₂S:Tb (gadolinium oxysulfide, doped with terbium with an emission maximum at approximately 545 nm), Gd₂O₂S:Pr,Ce,F (gadolinium oxysulfide, doped with praseodymium or cerium or fluorine with an emission maximum at approximately 510 nm), YAG:Ce (yttrium-aluminum-garnet doped with cerium with an emission maximum at approximately 550 nm), CsI:Tl (caesium iodide, doped with thallium with an emission maximum at approximately 525 nm), CdI₂:Eu (europium-doped cadmium iodide with an emission maximum at approximately 580 nm) or Lu₂O₃:Tb (lutetium oxide doped with terbium with an emission maximum at approximately 545 nm), are characterized by an emission maximum in the range of 515 nm to 580 nm and are thereby well configured for the absorption maximum of poly(3-hexylthiophene-2,5-diyl) (P3HT) (as an example photoactive material of the organic matrix) at 550 nm. The scintillator Bi₄Ge₃O₁₂ or BGO (bismuth germanate with an emission maximum at approximately 480 nm) can be combined well with poly[2-methoxy-5-(2-ethylhexyloxy)-1, 4-phenylenevinylene] (MEH-PPV) or poly[2-methoxy-5-(3′,7′-dimethyloctyloxy)-1,4-phenylenevinylene] (MDMO-PPV) which have good absorption in the range 460 nm to 520 nm.

Suitable blue scintillators should also be mentioned. An attractive material combination with emission in blue is provided by Lu₂SiO₅:Ce or LSO (caesium-doped lutetium oxyorthosilicate with an emission maximum at approximately 420 nm), Lu₁.8Y.2SiO₅:Ce (lutetium oxyorthosilicate doped with cerium with an emission maximum at approximately 420 nm), CdWO₄ (cadmium tungstate with an emission maximum at approximately 475 nm), CsI:Na (caesium iodide doped with sodium with an emission maximum at approximately 420 nm), or NaI:Tl (thallium doped sodium iodide with an emission maximum at approximately 415 nm), Bi₄Ge₃O₁₂ or BGO (bismuth germanate with an emission maximum at approximately 480 nm), Gd₂SiO₅ or GSO (gadolinium oxyorthosilicate doped with cerium with an emission maximum at approximately 440 nm), or CsBr:Eu (caesium bromide doped with europium with an emission maximum at approximately 445 nm) which can be well combined with typical wideband gap semiconductors (semiconductors with a large bandgap) such as poly[(9,9-di-n-octylfluorenyl-2,7-diyl)-alt-(benzo[2,1,3]thiadiazol-4,8-diyl)] (F8BT) (absorption maximum at 460 nm) or other polyfluorene (PFO) polymers and co-polymers (absorption at 380 nm to 460 nm).

Red scintillators such as Lu₂O₃:Eu (lutetium oxide doped with europium with an emission maximum at approximately 610 nm to 625 nm), Lu₂O₃:Tb (lutetium oxide doped with terbium with an emission maximum at approximately 610 nm to 625 nm) or Gd₂O₃:Eu (gadolinium oxysulfide doped with europium with an emission maximum at approximately 610 nm to 625 nm), YGdO:(Eu,Pr) (europium- and/or praseodymium-doped yttrium gadolinium oxide with an emission maximum at approximately 610 nm), GdGaO:Cr,Ce (chromium- and/or caesium-doped gadolinium gallium oxide), or CuI (copper iodide with an emission maximum at approximately 720 nm) can be well combined with absorbers, as have been developed for the OPV (organic photovoltaic), for example poly[2,1,3-benzothiadiazol-4,7-diyl[4,4-bis(2-ethylhexyl)-4H-cyclopenta[2,1-b:3, 4-b′]dithiophene-2,6-diyl]] (PCPDTBT), squaraine (e.g. hydrazone end-capped symmetrical squaraine with glycolic functionalization or diazulene squaraine), polythieno[3,4-b]thiophene (PTT), poly(5,7-bis(4-decanyl-2-thienyl)-thieno(3,4-b)diathiazolthiophene-2,5) (PDDTT).

Of these pairs: Gd₂O₂S:Tb or YAG:Ce in combination with P₃HT:PCBM, Lu₂SiO₅:Ce in combination with F₈BT or YGdO:Eu with PCPDTBT should be emphasized in particular according to preferred embodiments.

The inventive concept can be extended, however, to embodiments of all direct or quasi-direct conversion X-ray detectors or detectors for ionizing radiation, in particular in which trap states can occur at the interface, e.g. perovskites, but also to established systems such as a:Se. Quasi-direct means that the emitted light of the scintillators is directly absorbed by the surrounding semiconductor. The penetration depth is a good deal less than the pixel size, and therefore for the respective pixel there is a quasi-direct X-ray to charge carrier conversion or conversion to charge carriers from ionizing radiation right away.

Suitable as perovskites, which can be provided as scintillators, are, for example, those of the ABX₃ and/or AB₂X₄ type therefore, where A is at least a mono-, di- or trivalent element from the fourth period of the periodic table, preferably, Sn, Ba, Pb, Bi; B is a monovalent cation whose volume parameter satisfies perovskite lattice formation in the case of the respective element A, preferably monovalent, amino group-containing, positively charged carbon compounds, more preferably amidinium ions, guanidinium ions, isothiuronium ions, formamidinium ions, and primary, secondary, tertiary, and quaternary organic ammonium ions, particularly preferably having 1 to 10 carbons; and X is chosen from the anions of halides and pseudohalides, preferably from the anions chloride, bromide and iodide and blends thereof, for example CH₃—NH₃I:PbI₂ (═Pb CH₃NH₃I₃), CH₃—CH₂—NH₃T:PbI₂ (═Pb CH₃NH₃I₃), HO—CH₂—CH₂—NH₃:PbI₂ (═Pb HO—CH₂—CH₂—NH₃I₃), and Ph-CH₂—CH₂—NH₃I: PbI₂ (═Pb(Ph-CH₂—CH₂—NH₃)2 I₄).

According to specific embodiments the first layer comprises an organic donor-acceptor mixture (BHJ) comprising two organic compounds, wherein preferably the material of the first and optionally second interlayer then comprises only one of the two organic compounds respectively, preferably different organic compounds respectively, in order to improve the electron transport in relation to one electrode and the hole transport in relation to the other electrode. Therefore, for example, P3HT can be provided on the anode-side in the corresponding interlayer, while PCBM can be provided on the cathode side.

According to specific embodiments, the first layer and the first interlayer and optionally the second interlayer are matched to each other in terms of their area, wherein they can also differ here according to the measurement geometry for the radiation to be detected. The first and second electrodes can also be adapted to the layers here and be applied in a planar manner, although they can also be provided in another form, for example in the form of one or more elongate electrode(s), a lattice, etc. The first radiation source and optionally the second radiation source can accordingly also be adapted to the layers or not, wherein, in addition to the measurement geometry, other aspects, such as spatial availability or steric or stability aspects, etc., can also be incorporated.

The first electrical contact and/or the second electrical contact is/are not particularly limited, so they are essentially transmissible, preferably completely transmissible, for the radiation to be detected and according to specific embodiments the first and also the second electrical contact can each be provided on a substrate, although it is also possible for just one electrical contact to be applied to a substrate. The same or different substrates can be provided in this connection.

The substrates should be provided in accordance with the optical properties of the respective electrode. If, therefore, the first or second electrical contact respectively is essentially transmissible or transparent, preferably completely transmissible, for the radiation to be detected, the corresponding substrate should also be essentially transmissible, preferably completely transmissible, for the radiation to be detected. If the first and/or second electrical contact is/are essentially transmissible, preferably completely transmissible, for the radiation of the first and/or second radiation source(s), the respective substrate should also be essentially transmissible, preferably completely transmissible, for the radiation of the first and/or second radiation source(s). Example suitable substrates comprise, for example, various types of glass, metal or alloys, ceramics and/or polymers for various UV/vis, UV, vis, IR radiation sources as the first and/or second radiation source(s), wherein the various substrates should preferably have an appropriate semi-transparency or transparency according to the irradiated radiation of the first and/or second radiation source(s).

According to an embodiment of the invention, the first electrical contact and/or the second electrical contact, for example the anode, is/are not particularly limited if they are essentially transmissible, preferably completely transmissible, for the radiation to be detected, so the rays to be detected have to penetrate through the respective contact to the first layer. If, therefore, irradiation occurs, for example with rays to be detected at the side of the second electrode/the second electrical contact, this should be essentially transmissible, preferably completely transmissible, for the radiation to be detected. However, this does not preclude both electrical contacts from being essentially transmissible, preferably completely transmissible, for the radiation to be detected, for example if the radiation to be detected, after passing through the detection layer, i.e. the first layer, is to be reflected at the opposing side in order to thus amplify the detected signal.

According to specific embodiments, the first electrical contact is essentially transmissible, preferably completely transmissible, for the radiation of the first radiation source. According to specific embodiments, the second electrical contact is essentially transmissible, preferably completely transmissible, for the radiation of the second radiation source. According to specific embodiments, both electrical contacts are each essentially transmissible, preferably completely transmissible, for the radiation of the corresponding radiation source.

As described above, the first and second electrodes can be adapted to the layers and be applied in a planar manner, but can also be provided in a different form, for example in the form of one or more elongate electrodes, a lattice, etc.

Suitable electrode materials comprise, for example for the anode ITO (indium-tin oxide), FTO (fluorine-tin oxide), ZnO, AlZnO, PEDOT, PEDOT-CNT, silver nanowires, graphenes, metal lattices which is transparent or semi-transparent for UV-vis-IR radiation, and Ca/Ag, Ca/Al, thin Al as the cathode, which is semi-transparent for UV-vis-IR light. For the case where only one side of the detector is equipped with an interlayer and an associated radiation source the respective other electrode can also comprise materials which are not transparent or semi-transparent for UV-vis-IR light, e.g. Au, Ag, Pd, Pt on the anode side or Al, Ca, Ba, Li on the cathode side.

According to specific embodiments, the inventive detector also comprises a third radiation source for X-ray and/or gamma radiation. According to specific embodiments of medical imaging, in which humans or other living beings can be examined, although other objects can also be examined with the inventive detector, the inventive detector is used here, in particular in combination with a third radiation source. Radiations can also be detected which do not originate from a radiation source, such as, for example, in detectors for locating corresponding X-ray and/or gamma radiation.

The third radiation source for X-ray and/or gamma radiation is not particularly limited and conventional radiation sources can be used. According to specific embodiments the third radiation source can be provided at a slight distance from the first layer, e.g. in a range between 10 cm and 300 cm.

According to specific embodiments, the third radiation source can be provided on the side of the second electrical contact that opposes the first electrical contact, so possible absorption by the first radiation source, the substrate of the first electrode, the first electrode, and/or the first interlayer is minimized. If the first radiation source is provided so as to be essentially transmissible, preferably completely transmissible, for the radiation to be detected, the third radiation source can also be provided on the side of the first radiation source, and this can lead to simplification of the arrangement and, in particular, does not involve any further limitations on the second electrode, optionally with substrate, so there is a wider choice of material here.

In the case of imaging with the present detector, according to specific embodiments, an object to be examined is positioned between the third radiation source, X-ray and/or gamma source, and the first and/or second electrical contact, depending on which contact, optionally having the appropriate interlayers and optionally first or second radiation source(s), is essentially transmissible, for example completely transmissible, for the radiation to be detected.

In the case of detection of the radiation it is preferred that the third radiation source, the X-ray and/or gamma source(s), and the first and/or second radiation source(s) illuminate the detector simultaneously, so trapping is minimized in the respective interlayers. In this respect the present invention also relates to a method for examining an object, for example a life form, such as, for example, a mammal, e.g. a human or part of a human, but also a further lifeless objet, wherein the object is irradiated with the third radiation source and penetrating and/or scattered radiation is detected with the first layer in the detector, wherein preferably the third radiation source, the X-ray and/or gamma source(s), and the first and/or second radiation source(s) illuminate the detector simultaneously. In the prior art there are no interlayers present, for which reason irradiation with the first and/or second radiation is carried out shortly before or after irradiation with the third radiation source, for example an X-ray source.

According to specific embodiments, the first radiation source is an essentially transparent or completely transparent OLED film, or a comparable film such as a planar, light-emitting, electrochemical cell which is applied in a planar manner to the first electrical contact, also comprising a third radiation source for X-ray and/or gamma radiation, wherein the third radiation source is provided on the side of the first electrical contact opposite the second electrical contact.

According to a further embodiment of the present invention relates to a method for producing a detector for X-ray and/or gamma radiation, for example X-ray radiation, comprising:

(i) providing a first electrical contact, optionally on a substrate;
(ii) coating the first electrical contact with a first interlayer;
(iii) coating the first interlayer with a first layer which absorbs the X-ray and/or gamma radiation;
(iv) optionally coating with a second interlayer;
(v) coating with a second electrical contact;
(vi) providing a first radiation source which irradiates the first electrical contact with a first radiation which lies outside of the wavelength range to be detected, on the side of the first electrical contact opposite the second electrical contact; and
(vii) optionally providing a second radiation source which irradiates the second electrical contact with a second radiation which lies outside of the wavelength range to be detected, on the side of the second electrical contact opposite the first electrical contact;
wherein the first electrical contact, optionally the substrate and the first interlayer and/or the second electrical contact and the second interlayer are essentially transmissible, preferably completely transmissible, for the radiation to be detected, and the first interlayer essentially absorbs, preferably completely absorbs, the first radiation of the first radiation source.

Embodiments of inventive detectors in particular may be produced by embodiments of the inventive method.

The respective coating steps are not particularly limited and can be suitably provided. Therefore, the layers can, for example, be vapor deposited, doctor bladed, sprayed on, dripped on, spin-coated or sintered, with thicker layers in particular preferably being sintered. Sintering also provides the possibility of a plurality of layers being applied together and of being sintered together with the application of pressure. Provision of the radiation sources is not limited either, and these can be applied, for example, to the appropriate side of the electrical contacts or substrates, which can be provided for both electrical contacts or for just one of the two, for example glued on and/or pressed on, or the radiation sources can be provided at the side so the radiation is irradiated at the side and/or is redirected by mirrors, so there is nothing situated in the beam path of the radiation to be detected, etc. According to specific embodiments the first and/or second radiation source(s) is/are an OLED film, or a comparable film such as a planar light-emitting electrochemical cell which is/are applied in a planar manner to the first and/or second electrical contact(s).

According to specific embodiments, a third radiation source is provided in the inventive method for X-ray and/or gamma radiation, and, according to specific embodiments, this can be provided on the side of the second electrical contact opposite the first electrical contact.

According to specific embodiments, the first radiation source is an OLED film that is essentially transparent, preferably completely transparent, for the radiation to be detected or a corresponding film such as a planar light-emitting electrochemical cell which is applied in a planar manner to the first electrical contact, wherein the method also comprises providing a third radiation source for X-ray and/or gamma radiation, wherein a third radiation source is provided on the side of the first electrical contact opposite the second electrical contact.

According to specific embodiments, the first interlayer is coated in a thickness which at least matches the penetration depth of the first radiation of the first radiation source, preferably at least three times the penetration depth of the radiation of the first radiation source, more preferably at least five times the penetration depth of the radiation of the first radiation source, even more preferably at least ten times the penetration depth of the radiation of the first radiation source. According to specific embodiments the second interlayer is coated in a thickness which at least matches the penetration depth of the second radiation of the second radiation source, preferably at least three times the penetration depth of the radiation of the second radiation source, more preferably at least five times the penetration depth of the radiation of the second radiation source, even more preferably at least ten times the penetration depth of the radiation of the second radiation source. A signal generated by the radiation of the respective radiation source can be reduced or prevented in the first layer hereby.

According to specific embodiments, the first layer is made of a material which converts the absorbed X-ray and/or gamma radiation directly or quasi-directly into charge carriers, and the first layer is coated with this material.

According to specific embodiments, the first layer comprises an organic donor-acceptor mixture comprising two organic compounds, and the material of the first and optionally second interlayer just one of the two organic compounds, so the respective coatings can be made accordingly. According to specific embodiments the first layer comprises an organic donor-acceptor mixture comprising two organic compounds, and the material of the first interlayer just one of the two organic compounds, so the respective coatings can be made accordingly. According to specific embodiments the first layer comprises an organic donor-acceptor mixture comprising two organic compounds, and the material of the second interlayer just one of the two organic compounds, so the respective coatings can be made accordingly. Trapping can be reduced hereby and the layer transition can be improved, in particular with a joint sintering process for producing the layers.

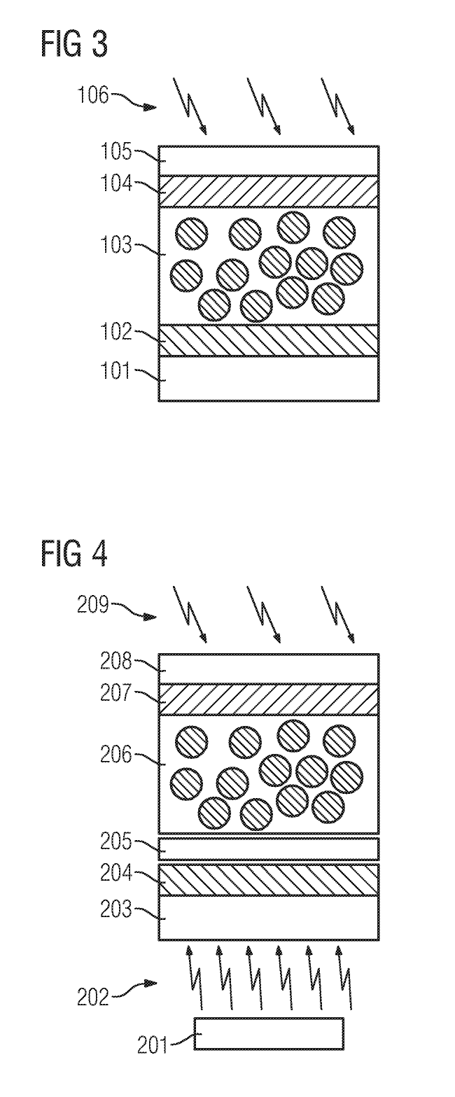

FIG. 3 schematically shows an example construction of existing detectors. A first electrical contact 102, e.g. an ITO electrode is applied to a substrate 101, e.g. glass, a polymer or metal, and a first layer 103 for the detection of X-ray and/or gamma radiation, e.g. a photoactive layer comprising a bulk heterojunction and a scintillator, is applied on top. A second electrical contact 104, e.g. aluminum, and a further second substrate 105 adjoins this as an encapsulation (e.g. glass+epoxy adhesive, or a film). The ionizing radiation 106 to be detected, i.e. X-ray and/or gamma radiation, e.g. X-ray radiation, is irradiated into this detector.

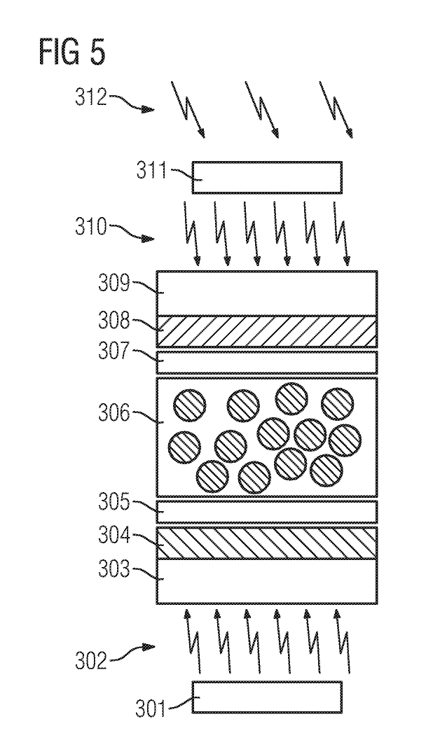

In contrast to this, an example embodiment of an inventive detector can be found in schematic FIG. 4. By way of a first radiation source 201, e.g. an LED (light emitting diode) or an OLED (organic light emitting diode), a first radiation 202, which should be absorbed in the first interlayer (e.g. green light in the case of P3HT used by way of example in the interlayer 205), is irradiated onto a first substrate 203, e.g. glass, a polymer or metal, and the first electrical contact 204, e.g. ITO (which is essentially transparent for green light). The first radiation 202 is essentially absorbed, preferably completely absorbed, in the first interlayer 205, e.g. comprising P₃HT or made of P₃HT. The highlighting of the first interlayer 205 shown here is provided in FIG. 4 solely to clarify its existence, wherein it is in contact with the first electrical contact 204 and the detection layer, the first layer 206, in real detectors. The first layer 206 is in turn used for the detection of X-ray and/or gamma radiation, for example X-ray radiation, and in turn comprises e.g. a photoactive layer comprising a bulk heterojunction and a scintillator. With X-ray detection, for example, a bulk heterojunction made of P₃HT/PCBM in conjunction with Gd₂O₂S:Tb, etc. can be used as the scintillator, with the first interlayer 205 then also being matched to the first layer 206. A second electrical contact 207, e.g. aluminum, in turn adjoins this and a further, second substrate 208 as an encapsulation (e.g. glass+epoxy adhesive, or a film). The ionizing radiation 210 to be detected, i.e. X-ray and/or gamma radiation, e.g. X-ray radiation, is also irradiated into this detector and detected in the first layer 206.

FIG. 5 schematically shows a further example embodiment of an inventive detector which largely matches the embodiment shown in FIG. 4. The first radiation source 301 (e.g. LED, OLED), the radiation 302 (e.g. green light), the first substrate 303 (e.g. glass, polymer and/or metal), the first electrical contact 304 (e.g. ITO), the first interlayer 305 (e.g. comprising P₃HT or made of P₃HT) and the first layer 306 (e.g. comprising a bulk heterojunction made of P₃HT/PCBM in conjunction with Gd₂O₂S:Tb or made thereof) therefore match their counterparts 201 to 206. A second interlayer 307 is accordingly provided in this embodiment, which, like the first interlayer 305, is highlighted for the purpose of clarification, although in a real detector it is connected to the first layer 306 and the second electrical contact 308. This second interlayer 307 is in turn matched, by way of example, to the first layer 306, in that it comprises e.g. PCBM or is made of PCBM.

A second electrical contact 308 adjoins which is made, for example, of the calcium-silver layer combination Ca/Ag. This is semi-transparent for irradiated UV radiation as example second radiation 310, just as the second substrate 309, e.g. glass+epoxy adhesive as encapsulation) can be designed so as to be transparent for the second radiation 310. The second radiation 310 is irradiated from a second radiation source 311, e.g. for UV light (e.g. LED, OLED). The ionizing radiation 312 to be detected, i.e. X-ray and/or gamma radiation, e.g. X-ray radiation, is irradiated by the second radiation facility 311, the second substrate 309, the second electronic contact 308 and the second interlayer 307 into the first layer 306 and detected there, wherein the elements 307, 308, 309 and 311 are designed here so as to be essentially transmissible or completely transmissible for the radiation 312 to be detected.

The respective materials can easily be matched and the generated trapping determined by studying the energy graphs of the respective materials used, in particular the HOMO (highest occupied molecular orbital) and LUMO (lowest unoccupied molecular orbital), the Fermi energy, etc.

As emerges from the schematically illustrated example embodiments in FIGS. 4 and 5, first and optionally second interlayers can be provided on the anode side and the cathode side. The introduction of an interlayer is therefore just as possible in a (semi-)transparent bottom contact as in a (semi-) transparent top contact which is illuminated with a suitable light in order to thereby minimize the trap states at this contact.

The present embodiments of detectors can be used in many cases to determine X-ray and/or gamma radiation, for example in medical imaging and in the material testing, but also for other purposes.

The above embodiments, designs and developments may, where expedient, be arbitrarily combined with each other. Further possible embodiments, developments and implementations of the invention also comprise combinations, not expressly stated, of features of the invention described above or below with reference to the example embodiments. In particular, a person skilled in the art will also add individual aspects as improvements or additions to the respective basic form of embodiments of the present invention.

### EXAMPLES

The invention will be illustrated below with reference to some example embodiments, although these do not limit the invention.

### Example 1

Example 1 is an X-ray detector having an anode-side P3HT interlayer.

The layer construction is as follows:

First electrical contact: ITO anode

First interlayer: P₃HT interlayer

First layer for the detection of X-ray radiation: P₃HT:PCBM Bulk heterojunction with Gd₂O₂S:Tb (GOS:Tb) scintillators

Second electrical contact: Al

The ITO anode is transparent for green light which is irradiated from a first radiation source. Furthermore, the X-ray radiation to be detected can pass the P3HT interlayer unhindered.

The penetration depth δ of green light in P₃HT is ˜110 nm. The layer thickness d of the interlayer should preferably be d>5 δ=0.55 μm. The layer thickness d of the P3HT interlayer is accordingly provided at d>0.55 μm. The irradiated green light from the first radiation source is almost completely absorbed in the interlayer, and only a minimal photocurrent is generated in the BHJ.

Since P₃HT and the BHJ of the first layer have the same HOMO level, there is essentially no additional energy barrier between the P₃HT interlayer and the BHJ. This leads to a virtually undisrupted hole-charge transport between the interlayer and the BHJ on the anode side.

The charge carriers absorbed in the interlayer fill the defects present there, excess charge carriers recombine. Charge carriers generated by X-ray radiation in the BHJ are not trapped by the defects, and a faster X-ray pulse response results.

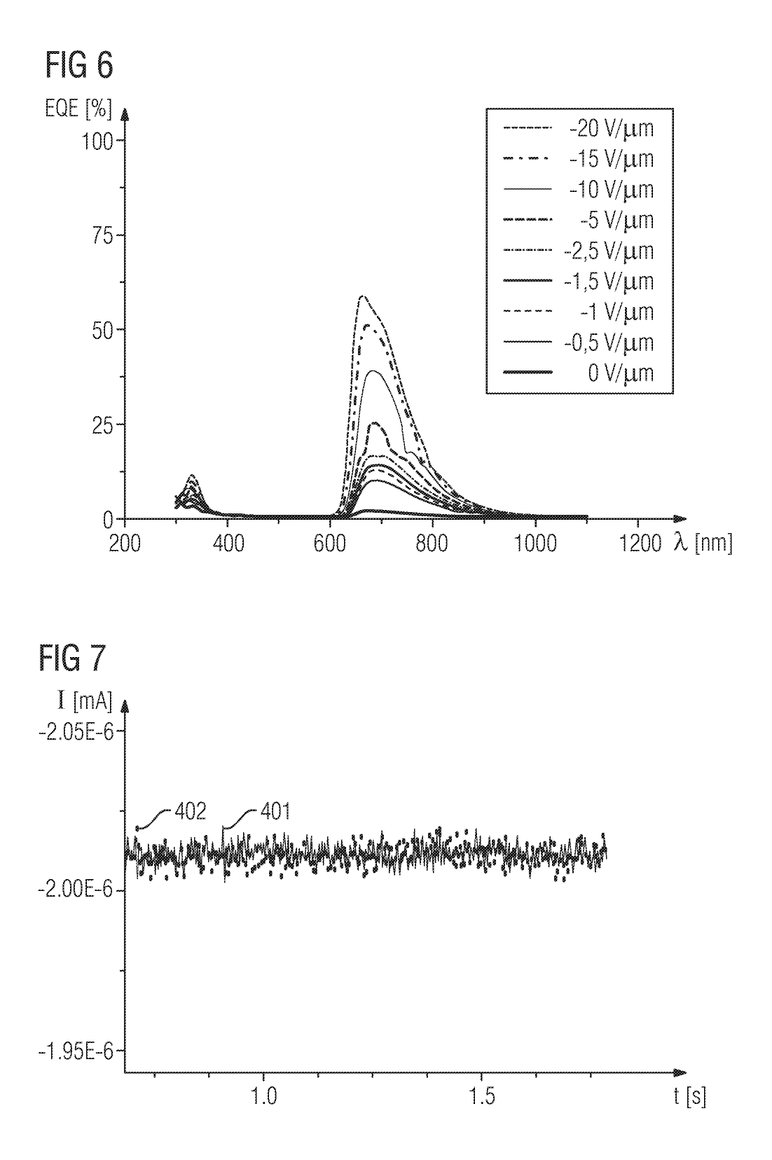

FIGS. 6 to 8 show results which would be achieved with a detector according to Example 1, wherein, instead of an ITO electrode, a Ca/Ag layer electrode has been used as the first electrode. Green light was used as the first radiation.

The detector has the following dimensions and characteristics:

First interlayer: P₃HT interlayer layer thickness 750 nm.

First layer for the detection of X-ray radiation: hybrid layer made of P₃HT:PCBM:GOS with a ratio of the proportions (% by weight) of 1:1:16 (P₃HT:PCBM:GOS) and a layer thickness of 10 μm.

First and second electrode: Ca/Ag with a thickness of 5 nm and 10 nm respectively.

Encapsulation: glass, secured with epoxy

Light bias (first radiation source): LED light source with 528 nm central wavelength and intensity in the interlayer of 0.01 mW/cm²

Detecting radiation: 70 kV X-ray braking radiation; 1 mGy(air)/s; 0.1 s illumination time

FIG. 6 shows the external quantum efficiency (EQE) of the detector as a function of the electrical field strength, with the external quantum efficiency correlating well with the electrical field strength.

FIG. 7 shows experimental results for the generated dark current with and without light irradiation. It is clear that no differences occur due to the absorbing interlayer.

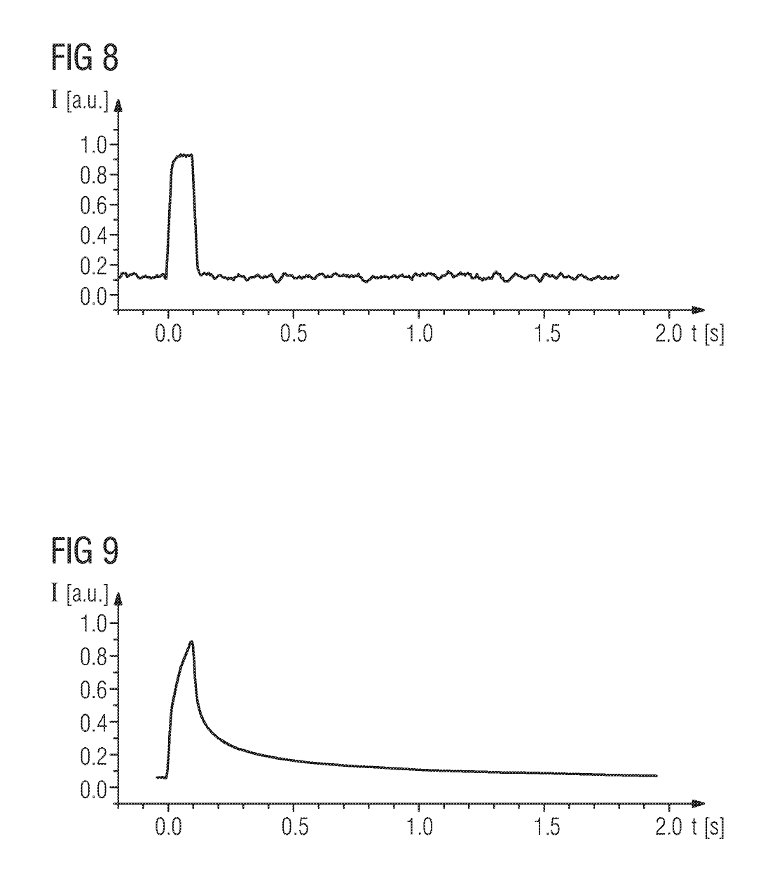

FIGS. 8 and 9 finally show the X-ray pulse response for the inventive example detector with and without irradiation with light from the LED light source. The much faster and better pulse response in the case of irradiation with light compared to the X-ray pulse response without irradiation (FIG. 9) can clearly be seen in FIG. 8, and this clearly emphasizes the effect of the improved response behavior of the present detector.

### Example 2

Example 2 is an X-ray detector with a cathode-side PCBM interlayer.

The layer construction is as follows:

Second electrical contact: ITO anode

First layer for the detection of X-ray radiation: P3HT:PCBM Bulk heterojunction with Gd₂O₂S:Tb (GOS:Tb) scintillators

First interlayer: PCBM interlayer

First electrical contact: Ca/Ag cathode

The Ca/Ag cathode is transparent for UV light which is irradiated from a second radiation source. In this case UV light is used as the light bias and is absorbed in the PCBM of the interlayer.

The penetration depth δ of UV light in PCBM is ˜500 nm. The layer thickness d of the interlayer should preferably be d>5 δ=2.5 μm. The layer thickness d of the interlayer PCBM is accordingly provided at d>2.5 pm.

PCBM and the BHJ have the same LUMO level, whereby there are essentially no additional energy barriers between the PCBM interlayer and the BHJ. This leads to a virtually undisrupted electron charge transport between the interlayer and the BHJ on the cathode side.

### Example 3

The two concepts can also be combined with each other, as is also shown schematically in FIG. 5. Example 3 combines the interlayer concepts from Example 1 and Example 2:

Example 3 is an X-ray detector with a cathode-side PCBM interlayer and an anode-side P3HT interlayer:

The layer construction is as follows:

First electrical contact: ITO anode

First interlayer: P3HT interlayer

First layer for the detection of X-ray radiation: P3HT:PCBM Bulk heterojunction with Gd₂O₂S:Tb (GOS:Tb) scintillators

Second interlayer: PCBM interlayer

Second electrode: Ca/Ag cathode

The ITO anode is transparent for green light which is irradiated from a first radiation source, and the Ca/Ag cathode is transparent for UV light which is irradiated from a second radiation source.

The penetration depth δ of green light in P3HT is ˜110 nm, and the penetration depth δ of UV light in PCBM is ˜500 nm.

The layer thickness d of the interlayer P₃HT is accordingly provided at d>0.55 μm, and the layer thickness d of the interlayer PCBM at d>2.5 μm.

Since P₃HT and the BHJ of the first layer have the same HOMO level, there is essentially no additional energy barrier between the P₃HT interlayer and the BHJ. This leads to a virtually undisrupted hole-charge transport between the interlayer and the BHJ on the anode side. Furthermore, PCBM and the BHJ have the same LUMO level, whereby there is essentially no additional energy barrier between the PCBM interlayer and the BHJ. This leads to a virtually undisrupted electron-charge transport between the interlayer and the BHJ on the cathode side.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A detector for at least one of X-ray and gamma radiation, comprising:
a first radiation source to irradiate a first electrical contact with a first radiation which lies outside of the wavelength range to be detected;
a first electrical contact;
a first interlayer;
a first layer to absorb the radiation to be detected; and
a second electrical contact, wherein at least one of
the first electrical contact and the first interlayer and
the second electrical contact and a second interlayer are essentially transmissible for the radiation to be detected, and wherein the first interlayer is useable to essentially absorb the first radiation of the first radiation source.

2. The detector of claim 1, wherein the first electrical contact is essentially transmissible for the radiation of the first radiation source.

3. The detector of claim 1, further comprising another radiation source for at least one of X-ray and gamma radiation.

4. The detector of claim 1, wherein the first radiation source is an OLED film which is applied in a planar manner to the first electrical contact.

5. The detector of claim 1, wherein the first radiation source is an OLED film essentially transparent for the radiation to be detected, applied in a planar manner to the first electrical contact, the detector further comprising:
another radiation source for at least one of X-ray and gamma radiation, wherein the another radiation source is provided on the side of the first electrical contact opposite the second electrical contact.

6. The detector of claim 1, wherein the first interlayer has a thickness matching at least the penetration depth of the first radiation of the first radiation source.

7. The detector of claim 1, wherein the first layer is made of a material to convert the absorbed at least one of X-ray and gamma radiation directly or quasi-directly into charge carriers.

8. The detector of claim 1, wherein the first layer comprises an organic donor-acceptor mixture comprising two organic compounds, and the material of the first interlayer comprises only one of the two organic compounds.

9. A method for producing a detector for at least one of X-ray and gamma radiation, comprising:
providing a first electrical contact;
coating the first electrical contact with a first interlayer;
coating the first interlayer with a first layer to absorb the at least one of X-ray and gamma radiation;
coating with a second electrical contact; and
providing a first radiation source to irradiate the first electrical contact with a first radiation which lies outside of the wavelength range to be detected, on a side of the first electrical contact opposite the second electrical contact, wherein at least one of the first electrical contact and the first interlayer, and the second electrical contact and a second interlayer are essentially transmissible for the radiation to be detected, the first interlayer being useable to essentially absorb first radiation of the first radiation source.

10. The method of claim 9, further comprising:
providing another radiation source for at least one of X-ray and gamma radiation, wherein the another radiation source is provided on the side of the second electrical contact opposite the first electrical contact.

11. The method of claim 9, wherein the first radiation source is an OLED film which is applied in a planar manner to the first electrical contact.

12. The method of claim 9, wherein the first radiation source is an OLED film essentially transparent for the radiation to be detected, applied in a planar manner to the first electrical contact, the method further comprising:
providing another radiation source for at least one of X-ray and gamma radiation, wherein the another radiation source is provided on a side of the first electrical contact opposite the second electrical contact.

13. The method of claim 9, wherein the first interlayer is coated in a thickness which matches at least the penetration depth of the first radiation of the first radiation source.

14. The method of claim 9, wherein the first layer is made of a material useable to convert absorbed at least one of X-ray and gamma radiation directly or quasi-directly into charge carriers.

15. The method of claim 9, wherein the first layer comprises an organic donor-acceptor mixture comprising two organic compounds, and the material of the first interlayer comprises only one of the two organic compounds.

16. The detector as claimed in claim 1, wherein the first electrical contact is on a substrate, the detector further comprising:
the second interlayer; and
a second radiation source to irradiate the second electrical contact with a second radiation which lies outside of the wavelength range to be detected, wherein at least one of
the first electrical contact, the substrate and the first interlayer and
the second electrical contact and the second interlayer are essentially transmissible for the radiation to be detected.

17. The detector of claim 2, further comprising another radiation source for at least one of X-ray and gamma radiation.

18. The detector of claim 16, further comprising a third radiation source for at least one of X-ray and gamma radiation.

19. The detector of claim 16, wherein at least one of the first and second radiation source is an OLED film which is applied in a planar manner to at least one of the first and second electrical contacts.

20. The detector of claim 16, wherein the first radiation source is an OLED film essentially transparent for the radiation to be detected, applied in a planar manner to the first electrical contact, the detector further comprising:
a third radiation source for at least one of X-ray and gamma radiation, wherein the third radiation source is provided on the side of the first electrical contact opposite the second electrical contact.

21. The detector of claim 16, wherein the first interlayer has a thickness matching at least the penetration depth of the first radiation of the first radiation source.

22. The detector of claim 16, wherein the first layer is made of a material to convert the absorbed at least one of X-ray and gamma radiation directly or quasi-directly into charge carriers.

23. The detector of claim 16, wherein the first layer comprises an organic donor-acceptor mixture comprising two organic compounds, and the material of the first interlayer comprises only one of the two organic compounds.

24. The method of claim 9, wherein the first electrical contact is provided on a substrate, the method further comprising:
coating with a second interlayer; and
providing a second radiation source to irradiate the second electrical contact with a second radiation which lies outside of the wavelength range to be detected, on a side of the second electrical contact opposite the first electrical contact, wherein at least one of
the first electrical contact, the substrate and the first interlayer, and
the second electrical contact and the second interlayer are essentially transmissible for the radiation to be detected.

25. The method of claim 24, further comprising:
providing a third radiation source for at least one of X-ray and gamma radiation, wherein the third radiation source is provided on the side of the second electrical contact opposite the first electrical contact.

26. The method of claim 24, wherein at least one of the first and second radiation source is an OLED film which is applied in a planar manner to at least one of the first and second electrical contact.

27. The method of claim 10, wherein the first radiation source is an OLED film which is applied in a planar manner to the first electrical contact.

28. The method of claim 24, wherein the first radiation source is an OLED film essentially transparent for the radiation to be detected, applied in a planar manner to the first electrical contact, the method further comprising providing a third radiation source for at least one of X-ray and gamma radiation, wherein the third radiation source is provided on a side of the first electrical contact opposite the second electrical contact.

29. The method of claim 24, wherein the first interlayer is coated in a thickness which matches at least the penetration depth of the first radiation of the first radiation source.

30. The method of claim 24, wherein the first layer is made of a material useable to convert absorbed at least one of X-ray and gamma radiation directly or quasi-directly into charge carriers.

31. The method of claim 24, wherein the first layer comprises an organic donor-acceptor mixture comprising two organic compounds, and the material of the first interlayer comprises only one of the two organic compounds.
